(19) United States
(12) Patent Application Publication
(10) Pub. No.: US 2013/0054482 A1
(43) Pub. Date: Feb. 28, 2013

(54) INTERVIEW ASSISTANT SYSTEM AND METHOD

(71) Applicants: Stefan Ehrler, Biblis (DE); Birgit Ludwig, Walldorf (DE)

(72) Inventors: Stefan Ehrler, Biblis (DE); Birgit Ludwig, Walldorf (DE)

(73) Assignee: SAP AG, Walldorf (DE)

(21) Appl. No.: 13/222,973

(22) Filed: Aug. 31, 2011

(51) Int. Cl. G06Q 10/06

(52) U.S. Cl. 705/321

(57) ABSTRACT

Systems and methods to provide interview assistance at a user device are provided. In example embodiments, a request to access candidate information for at least one candidate from a backend system is received at a user device. The request including an identifier of a user of the user device is provided to the backend system via a communication network. The candidate information for the at least one candidate specified for the user based on the identifier is received by the user device from the backend system. Additionally, assessment information for the at least one candidate is received from the user and provided to the backend system for storage.

### FIELD

The present disclosure relates generally to mobile computing, and in a specific example embodiment, to providing interview assistance to a mobile device.

### BACKGROUND

Conventionally, information for candidates in a hiring process are maintained and controlled by a human resource (HR) system of a company. The information may be distributed to managers or other employees for evaluation and interview preparation. The information may be distributed in hard copies or electronically sent, for example, in an e-mail to the managers or other employees. However, hard copies and e-mailed copies are not secure. For example, the employee may lose the hard copies. Alternatively, e-mailed copies maybe stored to a local storage of a computing device that is not secure or can be potentially lost.

Additionally, hard copies of candidate information may be cumbersome to take into a series of interviews. If there are several documents per candidate, a series of interviews (e.g., at a job fair or on-campus interview) may comprise hundreds of documents. Furthermore, hard copies or e-mailed information may not be updated with the most recent information on the candidate.

### BRIEF DESCRIPTION OF DRAWINGS

Various ones of the appended drawings merely illustrate example embodiments of the present invention and cannot be considered as limiting its scope.

FIG. 1 illustrates an environment in which example embodiments of the inventive subject matter may be practiced.

FIG. 2 is a block diagram illustrating a backend system.

FIG. 3 is a block diagram illustrating an interview assistant engine located on a mobile device.

FIG. 4a is a flowchart of an example method to enable candidate review and interview preparation on the mobile device.

FIG. 4b is a flowchart of an example method to enable candidate review and interview preparation at the backend system.

FIG. 5a is a flowchart of an example method to enable candidate assessment involving an interview on the mobile device.

FIG. 5b is a flowchart of an example method to enable candidate assessment involving an interview at the backend system.

FIG. 6a-6g are example screen shots of user interfaces for providing interview assistance.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for providing interview assistance at a user computing device are provided. The computing device may be a mobile device, PC, or tablet that allows a user to review and evaluate candidates by accessing all candidate data securely stored at a backend system. This allows the user, for example, to conduct a paperless interview while having access to all candidate information and documents including preparation notes of the user.

Example 1 is a non-transitory machine-readable medium that provides interview assistance at a user device. A request to access candidate information for at least one candidate from a backend system is received at a user device. The request including an identifier of a user of the user device is provided to the backend system via a communication network. The candidate information for the at least one candidate specified for the user based on the identifier is received by the user device from the backend system.

In Example 2, the subject matter of Example 1 can optionally include receiving assessment information for the at least one candidate and providing the assessment information to the backend system for storage.

In Example 3, the subject matter of Examples 1-2 can optionally include wherein the assessment information comprises a selection of at least one of a rating, indication of acceptance, indication of rejection, or feedback.

In Example 4, the subject matter of Examples 1-3 can optionally include receiving a bookmark indication for at least one document of the candidate information and providing the bookmark indication for the at least one document to the backend system for storage.

In Example 5, the subject matter of Examples 1-4 can optionally include receiving a remark that is viewable by others viewing the candidate information and providing the remark to the backend system for storage.

In Example 6, the subject matter of Examples 1-5 can optionally include receiving a sort command that filters a worklist containing at least one candidate assessment from the backend system.

In Example 7, the subject matter of Examples 1-6 can optionally include receiving a selection of a document, the operations further comprising providing a full screen of the selected document.

In Example 8, the subject matter of Examples 1-7 can optionally include receiving a selection of a note icon, the operation further comprising providing a full text of the selected note.

In Example 9, the subject matter of Examples 1-8 can optionally include receiving an indication of a completed activity, the operations further comprising causing an update to an activity log with the completed activity.

In Example 10, the subject matter of Examples 1-9 can optionally include receiving a note from the user, the note being viewable by the user and locally storing the note at the user device.

In Example 11, the subject matter of Examples 1-10 can optionally include receiving a selection of a category of a detailed candidate screen, the operations further comprising expanding the category for display of more detailed candidate information.

In Example 12, the subject matter of Examples 1-11 can optionally include wherein the category is a document category, the expanding of the category comprising displaying thumbnails of documents of the candidate information for the candidate.

In Example 13, the subject matter of Examples 1-12 can optionally include wherein the category is a notes category, the expanding of the notes category comprising displaying notes inputted for the candidate.

In Example 14, the subject matter of Examples 1-13 can optionally include wherein the category is an activity log category, the expanding of the activity log category comprising displaying a log of activities performed with the candidate.

Example 15 is a method for providing interview assistance. At a backend system, a request for access to candidate information from a user device via a communication network is received. An identity of a user of the user device based on the request is determined. Using at least one processor, access to the candidate information designated for the identified user of the user device based on the identifier is provided.

In Example 16, the subject matter of Example 15 can optionally include receiving assessment information for a candidate corresponding to the requested candidate information from the user device and storing the assessment information to the candidate information for the candidate at the backend system.

In Example 17, the subject matter of Examples 15-16 can optionally include providing a success message to the user device indicating successful submission of the assessment information and removing the candidate from a worklist of the user based on the successful submission of the assessment information.

In Example 18, the subject matter of Examples 15-17 can optionally include receiving a remark from the user device and storing the remark to the candidate information for the candidate at the backend system.

In Example 19, the subject matter of Examples 15-18 can optionally include receiving a bookmark indication for a document of the candidate from the user device and storing the bookmark indication for the document to the candidate information for the candidate at the backend system.

In Example 20, the subject matter of Examples 15-19 can optionally include providing an interview assistant application for download to the user device.

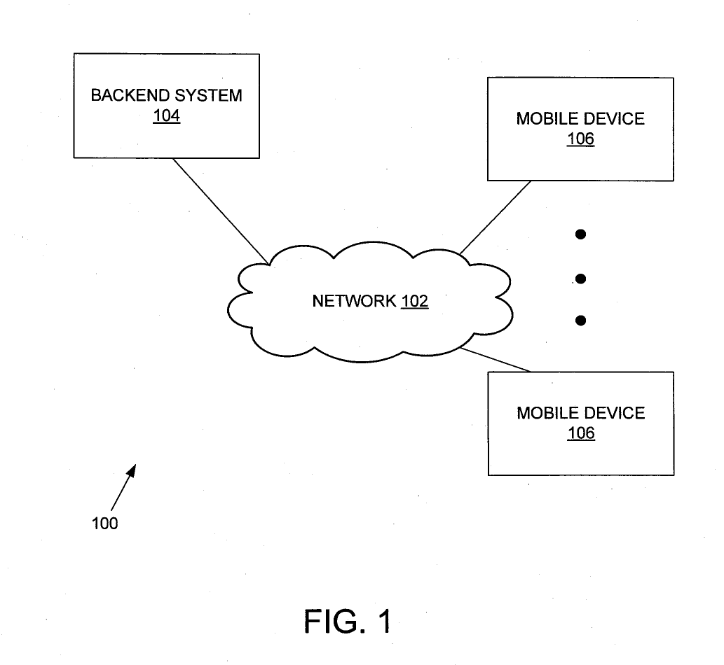

With reference to FIG. 1, an environment 100 in which example embodiments of the inventive subject matter may be practiced is shown. The environment 100 comprises a network 102 that communicatively couples a backend system 104 and one or more mobile devices 106. Other systems (not shown) may also be communicatively coupled via the network 102 to the backend system 104 or the mobile devices 106. The network 102 may comprise, for example, one or more of a wired or wireless network, a local area network (LAN), or a wide area network (WAN).

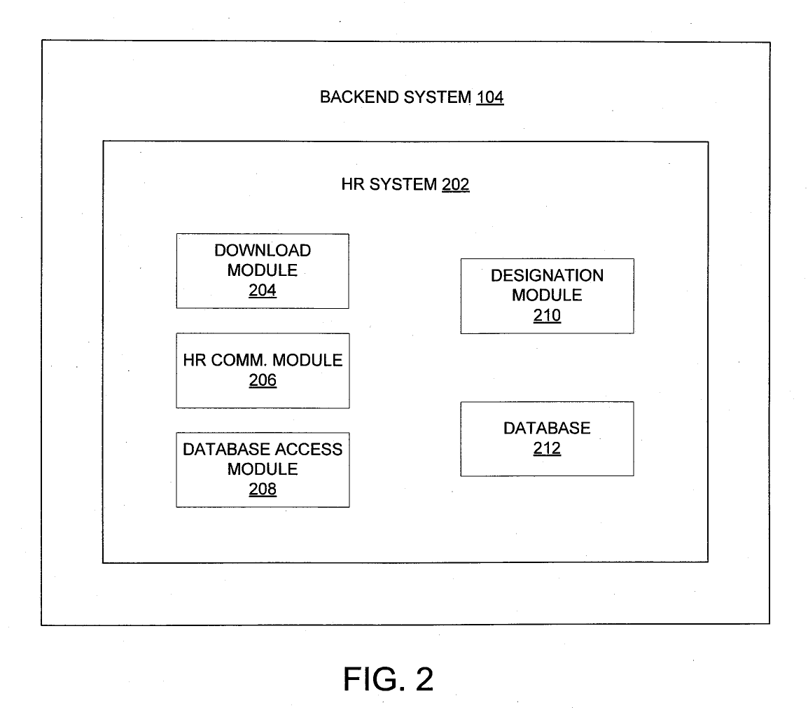

The backend system 104 is a system associated with a company's internal network of computing resources. In example embodiments, the backend system 104 is an on-premise system. For example, the backend system 104 may comprise an enterprise resource planning (ERP) system designed to support business processes such as managing sales orders, supplies, human resources, and financials. A human resource (HR) system of the backend system 104 will be discussed in more detail in connection with FIG. 2 below.

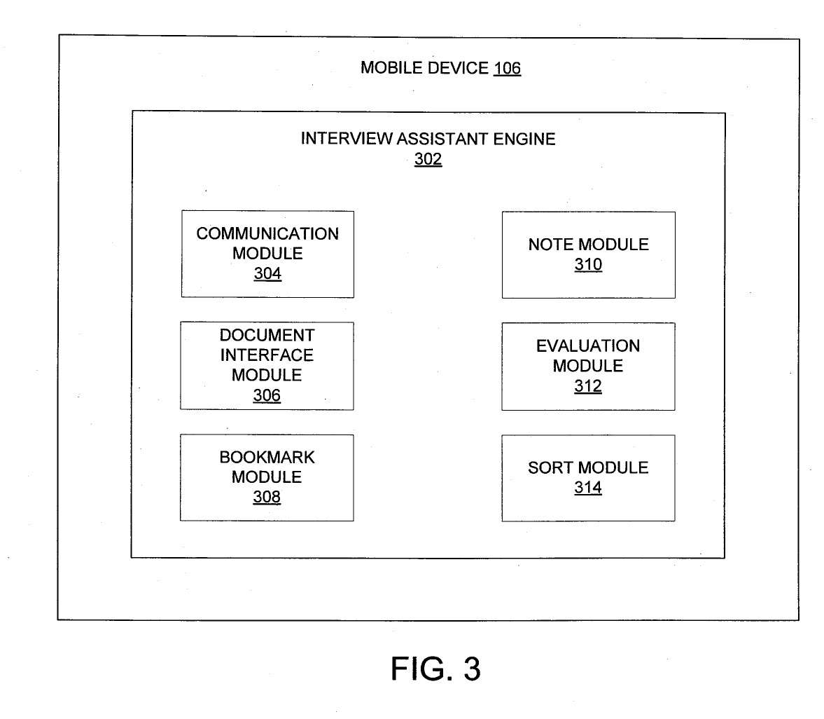

The mobile device 106 may be any device that is used by a user to access information stored at the backend system 104. In example embodiments, the computing device comprises a computing device such as, for example, a tablet, netbook, or smartphone. While example embodiments discuss a mobile device, alternative embodiments may be practiced on non-mobile devices such as, for example, a desktop computer (both mobile and non-mobile devices may be collectively referred to as “user devices”). The mobile device 106 will be discussed in further detail in connection with FIG. 3 below.

FIG. 2 is a block diagram illustrating a HR system 202 of the backend system 104. The HR system 202 manages recruitment information for the company. In example embodiments, the HR system 202 enables the generation and posting of open positions for the company. The HR system 202 further maintains information from candidates for the open positions and retains information for filled positions. The HR system 202 comprises a download module 204, a HR communication module 206, a database access module 208, a designation module 210, and a database 212. In an alternative embodiment, the database 212 may be located in a different location of the backend system 104 or be in a storage device coupled to the backend system 104. It should be noted that the HR system 202 and the backend system 104 may comprise other components, modules, and systems (not shown) that are not pertinent to execution of example embodiments of the inventive subject matter.

In example embodiments, the download module 204 provides an interview assistance application to the mobile device 106 of FIG. 1. The interview assistance application enables the mobile device 106 to communicatively couple to the HR system 202 to exchange information for candidate review, interview preparation, conducting an interview, and post-interview evaluation. The interview assistance application may be stored in the database 212 and provided to the mobile device 106 when requested by the mobile device 106. The download module 204 may also provide updates to the interview assistance application when available.

The HR communication module 206 allows exchange of information with the mobile device 106 when the mobile device 106 is actively performing interview assistance. For example, the HR communication module 206 may receive a request for information for a particular candidate. The information is retrieved by the database access module 208 from the database 212 and returned to the mobile device 106 by the HR communication module 206. In example embodiments, the information may be returned to the mobile device 106 in an encrypted format.

The database access module 208 obtains information from, and provides new information to, the database 212. Thus when the request for candidate information is received by the HR communication module 206, the database access module 208 retrieves the candidate information from the database 212 and provides the candidate information to the HR communication module 206 for transmission back to the mobile device 106. The database access module 208 may also update the database 212 with information received, for example, from the mobile device 106 via the HR communication module 206. The received information may include notes, assigned ratings, and evaluations inputted by a user of the mobile device 106 for a particular candidate. The database 212 may then be updated with this received information by the database access module 208.

The designation module 210 determines specific information to which a user is authorized or designated to have access. When a user uses their mobile device 106 to access candidate information from the HR system 202, an identifier of the user is provided to the designation module 210. Once identified, the designation module 210 determines the designated information to be provided to the user. The designated information may include, for example, a worklist containing candidate information to be reviewed by the user or a worklist of candidates scheduled for interviews with the user. The database access module 208 may then access the designated information.

FIG. 3 is a block diagram illustrating an interview assistant engine at the mobile device 106. In example embodiments, the interview assistant engine 302 is configured from the downloaded interview assistant application from the HR system 202 of FIG. 2. For example, the interview assistant application may be downloaded from the HR system 202 and stored into a non-transitory machine-readable medium of the mobile device 106. The interview assistant engine 302 may comprise a communication module 304, a document interface module 306, a bookmark module 308, a note module 310, an evaluation module 312, and a sort module 314. It should be noted that the interview assistant engine 302 and the mobile device 106 may comprise other components (not shown) that are not pertinent to the operations of example embodiments.

The communication module 304 exchanges information with the HR system 202 of the backend system 104. When a user of the mobile device 106 is utilizing the interview assistant engine 302, the communication module 304 sends information to and receives information from the HR system 202. For example, the communication module 304 may send a request for information for a particular candidate to the HR system 202. The requested information is received from the HR system 202 via the communication module 304.

The document interface module 306 renders and presents various user interfaces for display on a display device of the mobile device 106. In example embodiments, the document interface module 306 receives information from the communication module 304 along with inputs from the user of the mobile device 106 and configures the information for display (e.g., present the requested candidate information). Various examples of screenshots including user interfaces will be discussed below.

The bookmark module 308 manages bookmarks on documents associated with each candidate. For example, candidate information may comprise a plurality of documents such as, for example, a cover letter, a resume, transcripts, certifications, white papers, and recommendations. The user may want to tag a particular document for future or faster reference by bookmarking the document. By bookmarking the document, the document may be shown on the display with a graphical icon that distinguishes the document from non-bookmarked documents. Bookmarked documents may also be displayed with priority (e.g., shown first or at a beginning of a list of documents).

The note module 310 manages notes for documents associated with each candidate. The note module 310 also allows for notes related to the candidate in general. The notes are essentially Post-It® notes that are established by the user, for example, when reviewing documents for a particular candidate. The note module 310 allows a note to be added to a document by a user tapping at a location on a document where the note is desired and allowing the user to provide text in a note box. The note module 310 may indicate the note by providing a note icon on the document. In example embodiments, the notes are stored locally at the mobile device 106 and may only be viewable by the user

The evaluation module 312 manages an evaluation and submission process. In example embodiments, the evaluation module 312 provides an evaluation questionnaire to the user for completion. The evaluation questionnaire may request the user to provide feedback on a particular candidate and indicate whether to invite for an interview, to hire, or reject the candidate. In one embodiment, the questionnaire may be customized according to a job position type. Once completed the user submits the evaluation questionnaire to the HR system 202.

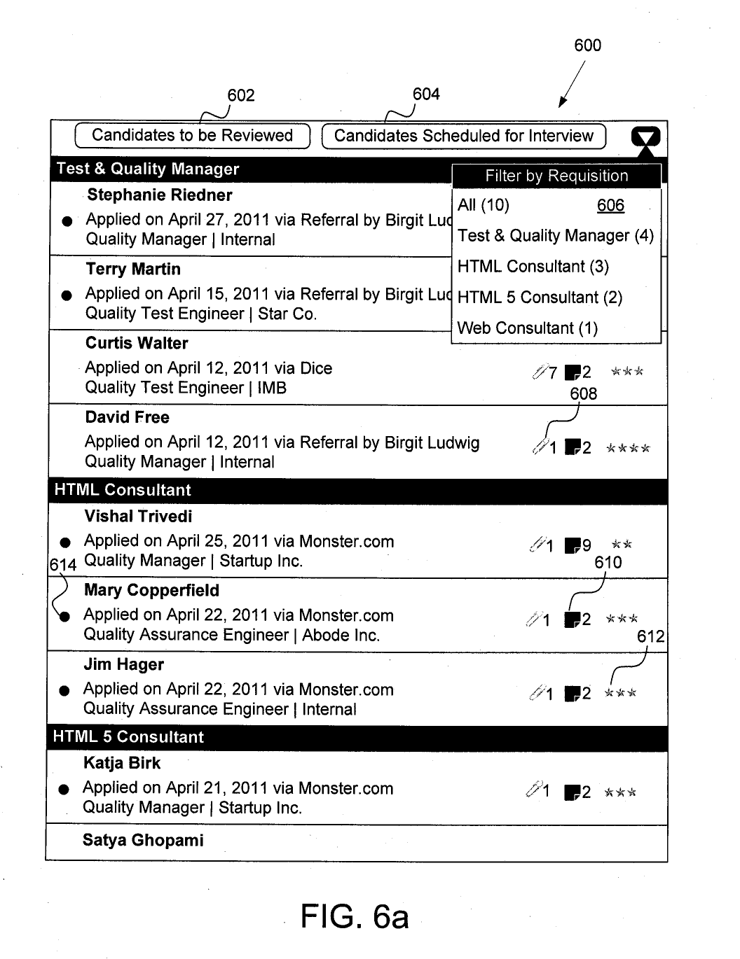

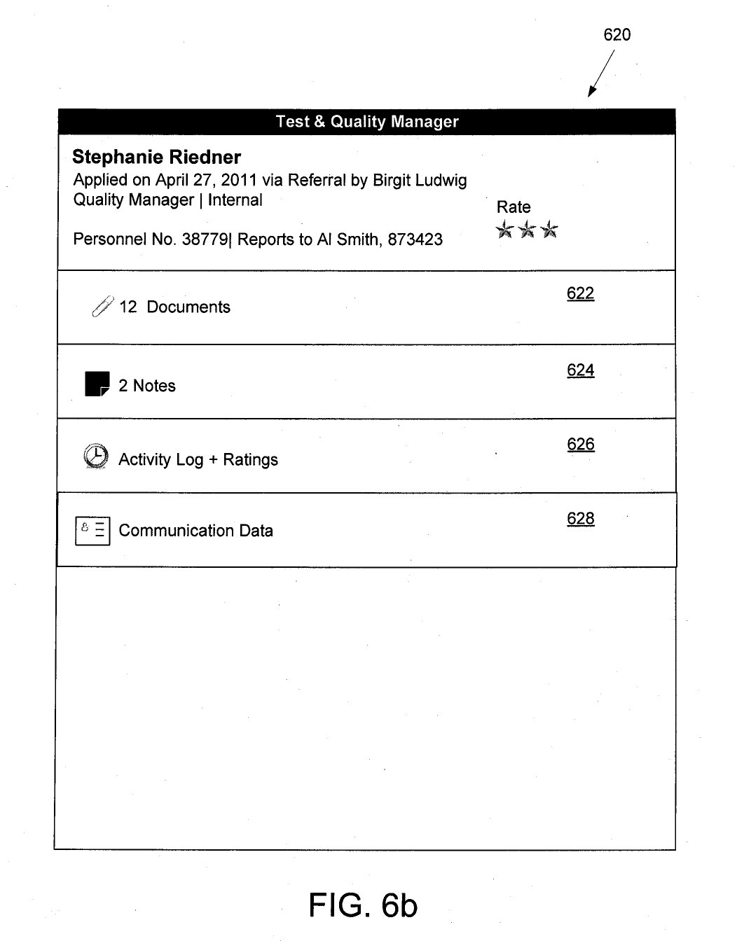

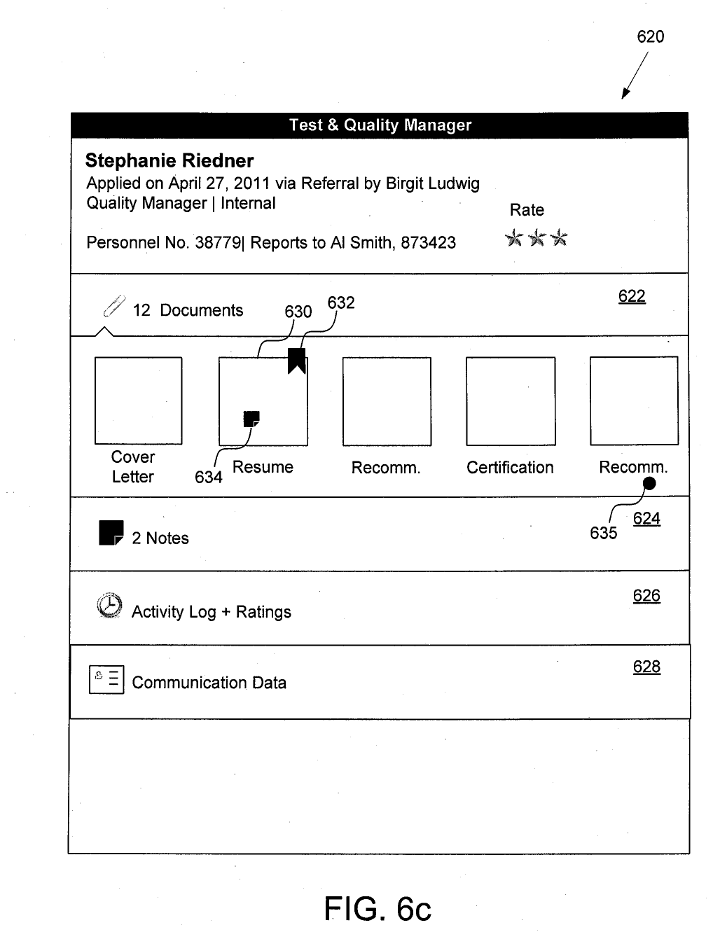

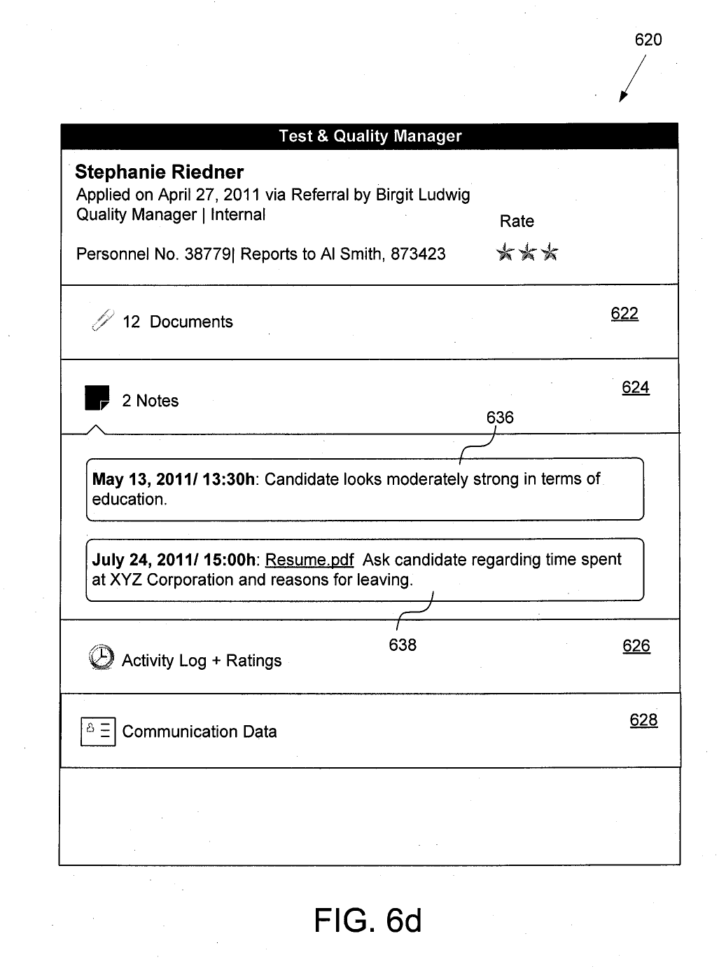

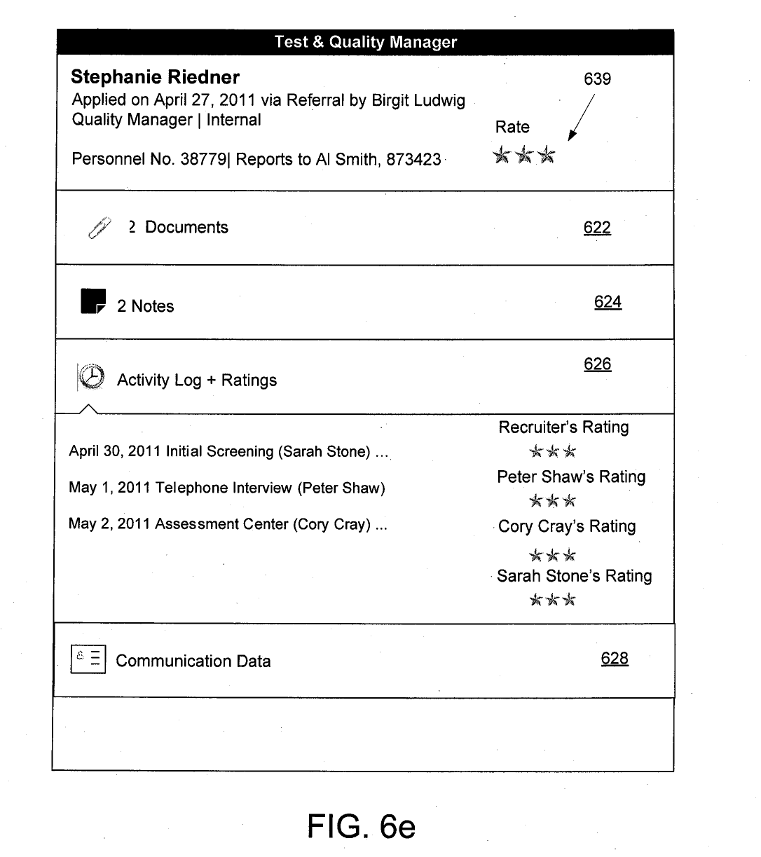

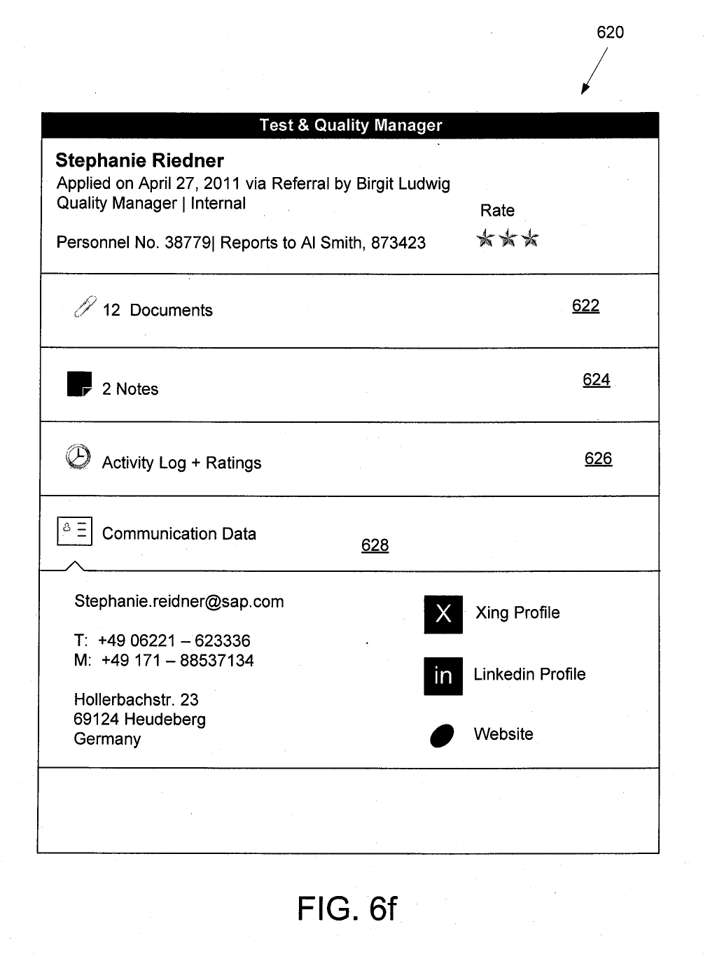

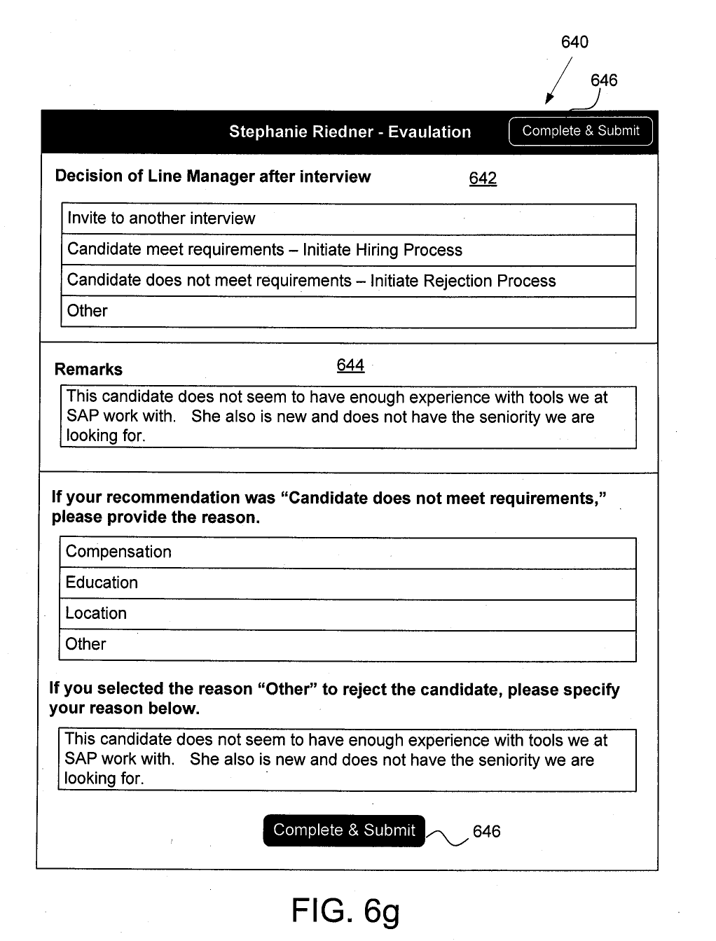

The sort module 314 sorts HR information at the mobile device 106. For example, the sort module 314 allows the user to sort candidate information according to job position, name, date of application, or any other sortable criteria. Example screenshots and user interfaces will be discussed in more detail in connection with FIG. 6 below.

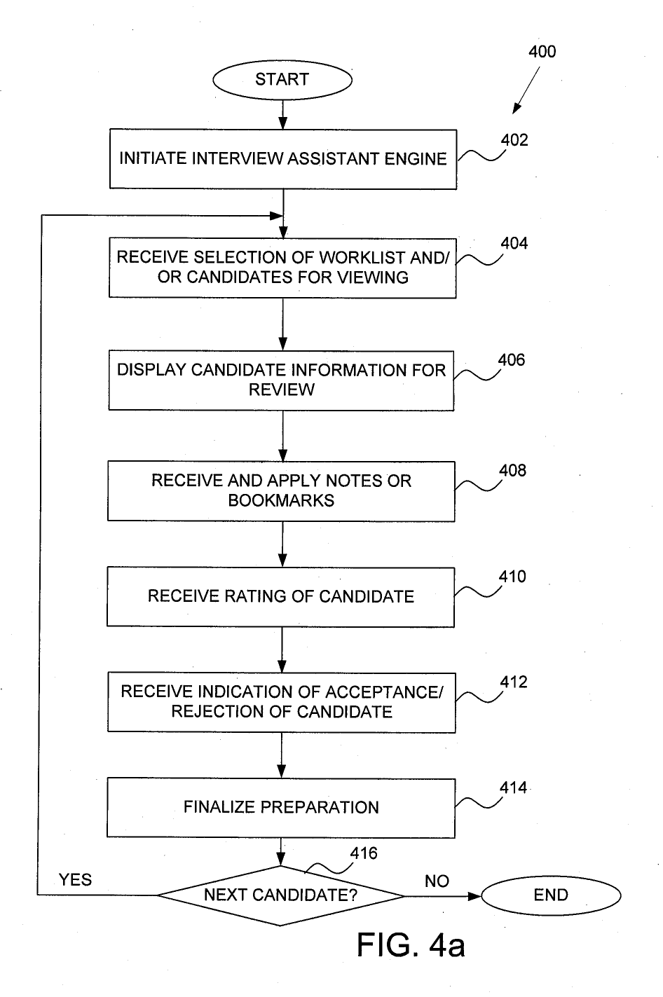

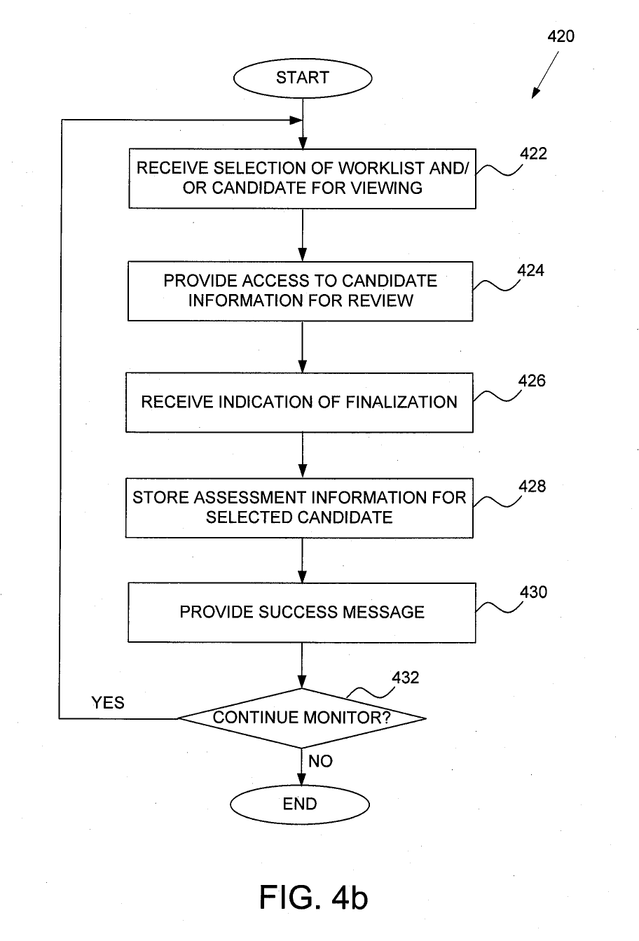

FIG. 4a is a flowchart of an example method 400 to enable candidate review and interview preparation on the mobile device 106. Using the method 400, the user may review and assess a list of candidates to determine which candidates to, for example, invite to an interview. The method 400 also allows the user to prepare for an interview by providing candidate information and allowing the user to review and annotate the candidate information.

In operation 402, the user of the mobile device 106 initiates the interview assistant engine 302. For example, the user may initiate the interview assistant engine 302 on their tablet or other mobile device by selecting a corresponding indicator for the interview assistant engine 302. The initiation of the interview assistant engine 302 may trigger a push (or a pull) of information from the backend system 104 (e.g., from the HR system 202) for information that the user is authorized or designated to access. In example embodiments, an identification of the user at the mobile device 106 is passed by the communication module 304 to the backend system 104 to identify and authenticate the user with the backend system 104. For example, a user name and password may be provided to the backend system 104 to identify the user.

Once the user is identified to the backend system 104, the backend system 104 may provide the designated information to the user. In operation 404, the mobile device 106 receives a selection of a worklist or a candidate for review from the user. A first worklist comprises a list of candidates to be reviewed to determine whether to invite for an interview or reject, while a second worklist may comprise a list of candidates scheduled for an interview. The user may select one of the worklists and a candidate from the selected worklist to review corresponding candidate information.

In operation 406, the candidate information is displayed to the user by the document interface module 306. The user may then review the candidate information and apply annotations or bookmarks to the candidate information. In operation 408, annotations or notes may be received from an input device of the mobile device 106 by the note module 310. The note module 310 may locally store the note to a storage device of the mobile device 106.

Operation 408 may also receive a bookmark indication from an input device of the mobile device 106. The bookmark module 308 will tag the document being bookmarked for easier and faster future reference.

In operation 410, the user of the mobile device 106 may rank the candidate. In some embodiments, the ranking may be received by the evaluation module 312 and used to overwrite any previous ranks received from other reviewers of the same candidate information. In other embodiments, the evaluation module 312 may supplement or average the previous ranks with the new ranking received from the user.

In operation 412, the evaluation module 312 receives an indication of acceptance or rejection of the candidate. Acceptance may, in one embodiment, be an indication to invite the candidate to an interview. In some embodiments, a preconfigured questionnaire is provided by the evaluation module 312 for completion. Relevant data regarding reasons for inviting the candidate for an interview or for rejecting the candidate is then received using the questionnaire by the evaluation module 312.

The preparation is finalized for the selected candidate in operation 414. In example embodiments, assessment information that is received from the user may be transmitted to the backend system 104 for storage. The assessment information may include, for example, the evaluation questionnaire responses, rankings, feedback, recommendations, and remarks. If the assessment information is successfully received, a message may be received from the backend system 104 confirming the receipt of the assessment information. In some embodiments, options may be provided to inform recruiters or assistants via an e-mail about follow up actions (e.g., send rejection letter).

In operation 416, a determination is made as to whether there is another candidate that the user would like to review. If there is another candidate, the method 400 returns to operation 404 where a selection of the next candidate is received.

It should be noted that the method 400 of FIG. 4a is an example. Alternative methods may contain more or less operations, combine or separate operations, or perform the operations in a different order. For example, operation 414 may be performed after all candidates have been assessed and the interview assistant engine 302 is shut down instead of after each assessment of a candidate.

FIG. 4b is a flowchart of an example method 420 to enable candidate review and interview preparation at the backend system 104. In operation 422, the HR system 202 of the backend system 104 receives, via the HR communication module 206, a selection of a worklist or candidates for review from the mobile device 106. In example embodiments, an identification of the user at the mobile device 106 is received by the HR communication module 206 to identify and authenticate the user with the backend system 104. In some cases, this may include receiving a user name and password to authenticate the user.

Once the user is identified to the backend system 104, the backend system 104 may access the database 212 via the database access module 208 to obtain the designated information to the user. In operation 424, the HR communication module 206 provides the designated worklist or candidate information to the mobile device 106.

In operation 426, the HR system 202 receives an indication of finalization of a candidate assessment. Along with the indication, assessment information may be received. The assessment information may include, for example, the evaluation questionnaire information, rankings, feedback, recommendations, and remarks. If the assessment information is successfully received, a message may be transmitted back to the mobile device 106 confirming the receipt of the assessment information in operation 430.

In operation 432, a determination is made as to whether to continue to monitor for further assessment information from the mobile device 106. If the backend system 104 is to continue to monitor, then the method 420 returns to operation 422.

In some embodiments, the backend system 104 will receive an indication when the interview assistant engine 302 shuts down at the mobile device 106. Furthermore in some embodiments, the indication of finalization and assessment information (operation 428) may not be received until the interview assistant engine 302 shuts down. In these embodiments, not all operations of the method 420 may be performed or may be performed in a different order.

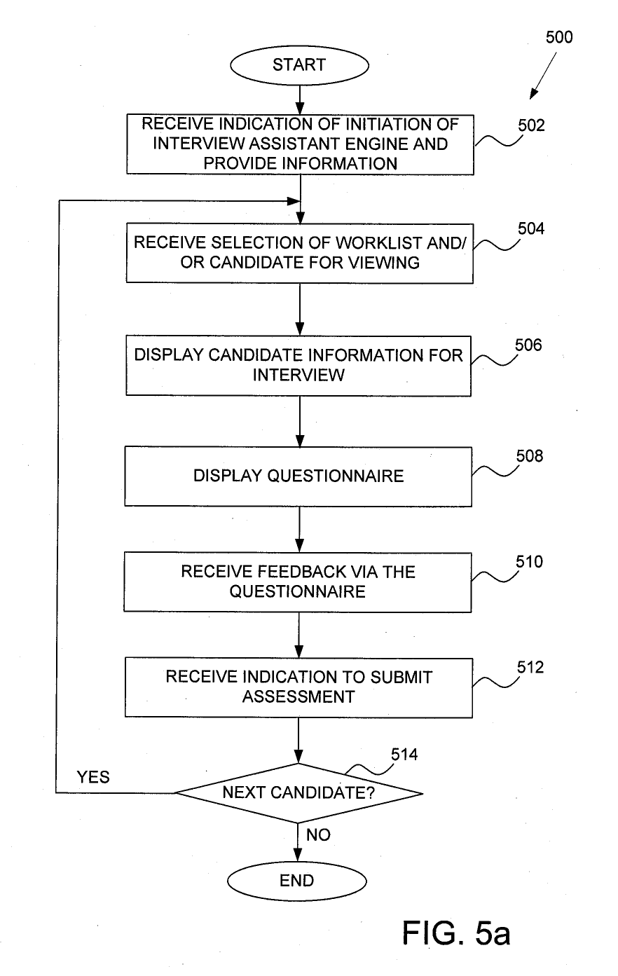

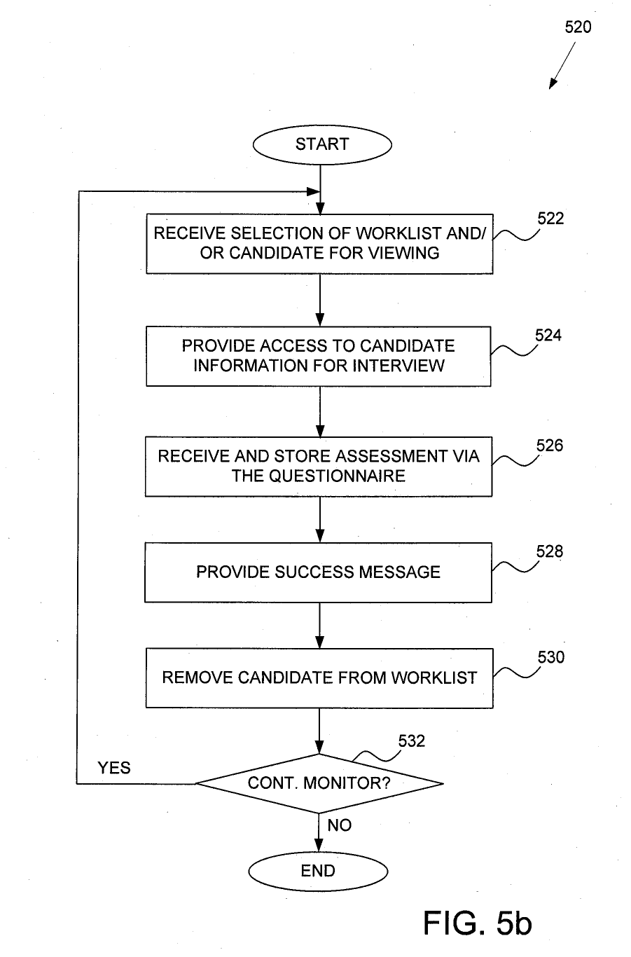

FIG. 5a is a flowchart of an example method 500 to enable candidate assessment involving an interview on the mobile device 106. When the user of the mobile device 106 initiates the interview assistant engine 302 on their mobile device 106, the initiation may trigger a push (or a pull) of information from the backend system 104 (e.g., from the HR system 202) for information that the user is authorized to access in operation 502. In some embodiments, an identification of the user at the mobile device 106 is passed by the communication module 304 to the backend system 104 to identify and authenticate the user with the backend system 104. Once the user is identified to the backend system 104, the backend system 104 may provide the appropriate information to the user.

In operation 504, the mobile device 106 receives a selection of a worklist or a candidate to review from the user. In this embodiment, the worklist is a list of candidates scheduled for an interview. From this worklist, the particular candidate being interviewed may be selected by the user.

In operation 506, the candidate information for the selected candidate is displayed to the user by the document interface module 306. The user may then review the candidate information. If the user has previously applied notes or bookmarks to the candidate information, these notes and bookmarks may be indicated on the appropriate documents that are noted or bookmarked. In an embodiment where private notes are locally stored, the private notes may be accessed by the note module 310 from a local storage device of the mobile device 106. The bookmark may, in some embodiments, also be accessed from a local storage device by the bookmark module 308. Alternatively, the bookmarks may be stored at the backend system 104 and retrieved for display. The user may then conduct the interview with all of the candidate information easily assessable and properly noted and bookmarked.

Upon completion of the interview, a questionnaire may be accessed and displayed in operation 508. For example, the user may select an indicator that requests the questionnaire. An example of the questionnaire will be discussed in more detail in connection with FIG. 6g below. Corresponding interview assessment information (e.g., feedback) in response to the questionnaire is received in operation 510 by the evaluation module 312. Once appropriate fields of the questionnaire are completed, an indication to submit the assessment is received in operation 512. For example, the user may select a “complete and submit” indicator associated with the questionnaire to submit the interview assessment information. The interview assessment information may then be submitted to the backend system 104.

A determination of whether a next candidate is to be interviewed is received in operation 514. If a next candidate is to be interviewed, then the method returns to operation 504.

It should be noted that the method 500 of FIG. 5a is an example. Alternative methods may contain more or less operations, combine or separate operations, or perform the operations in a different order. For example, operation 512 may be performed after all candidates have been assessed and the interview assistant engine 302 is shut down instead of after each interview and assessment of a candidate.

FIG. 5b is a flowchart of an example method 520 to enable candidate assessment at the backend system 104. In operation 522, the HR system 202 of the backend system 104 receives, via the HR communication module 206, a selection of a worklist or a particular candidate for interviewing from the mobile device 106. In some embodiments, an identification of the user at the mobile device 106 is received by the HR communication module 206 to identify and authenticate the user with the backend system 104.

Once the user is identified to the backend system 104, the backend system 104 may access the database 212 via the database access module 208 to obtain the designated information for the user. In operation 524, the HR communication module 206 provides the candidate information for a selected candidate being interviewed to the mobile device 106.

In operation 526, the HR system 202 receives and stores candidate interview assessment information. The interview assessment information may include, for example, information provided by the user in response to the post-interview questionnaire. If the assessment information is successfully received, a message may be transmitted back to the mobile device 106 confirming the receipt of the assessment information in operation 528.

The candidate is then removed from the worklist indicating candidates to be interviewed in operation 530. In some embodiments, a historical worklist may be maintained by the HR system 202 that indicates past candidates assessed by the user. In these embodiments, the candidate just removed from the scheduled interview worklist may be added to the historical worklist.

In operation 532, a determination is made as to whether to continue to monitor for further assessment information from the mobile device 106. If the backend system 104 is to continue to monitor, then the method 520 returns to operation 522.

In some embodiments, the backend system 104 receives the interview assessment information for all candidates at the same time (e.g., upon a single submission from the mobile device 106 or shut down of the interview assistant engine 302). In these embodiments, not all operations of the method 520 may be performed or may be performed in a different order.

FIG. 6a-6g are example screenshots of user interfaces for providing interview assistance at the mobile device 106. Referring to FIG. 6a, a start screen 600 is shown. In example embodiments, the start screen 600 comprises two worklists. A “candidates to be reviewed” worklist 602 comprises a list of candidates designated by the HR department for the user to review in order to determine which candidates to invite for an interview. A “candidates scheduled for interview” worklist 604 comprises a list of candidates for upcoming interview by the user. In example embodiments, only candidates to be reviewed or interviewed by the user of the mobile device 106 utilizing the interview assistant engine 302 are provided to the user based on an identity of the user. It is noted that the example screenshots are merely provided for illustration purposes and the embodiments of the present invention are not limited thereto. Alternative embodiments may comprise more, less, or other components on the screenshots or arrange the placement of components in a different order or location. Additionally, while the screenshots are shown in a portrait mode, it is noted that example embodiments may display the screenshots in a landscape mode.

Each list may be sorted by the sort module 314 via a requisition filter 606. In the example of FIG. 6a, the requisition filter 606 enables filtering by job posting (e.g., requisition). Additionally, the candidates within each requisition may be sorted based on name, ranking/rating, or application date on the “candidates to be reviewed” list. On the “candidates scheduled for interview” list, the candidates may further be sorted by closest upcoming interview start time.

Each candidate on the worklist is listed with additional information. The additional information includes, for example, date of application, application source, current job title, current or last employer, and an indication of whether the candidate is internal (including personnel number) or external to the company. Where applicable, additional information may also include a document indicator 608 indicating a number of documents associated with a candidate, a notes indicator 610 indicating a number of notes made for the candidate by the user, and a ranking 612 for the candidate. In one embodiment, the ranking 612 may indicate a ranking provided by the user of the mobile device 106 for each candidate. An unread indicator 614 may be provided to indicate candidates that the user has not reviewed.

When the user selects a candidate from the worklist of FIG. 6a, a candidate detailed screen 620 of FIG. 6b is presented. The candidate detailed screen 620 includes all of the information provided on the start screen 600 for the candidate. Thus, the date of application, application source, current job title, current employer, and an indication that the candidate is internal including personnel number is displayed. Because the candidate, in the example for FIG. 6b, is an internal employee, a person to whom the candidate reports to is also provided.

The various indicators from the start screen 600 are illustrated as selectable categories on the candidate detailed screen 620. For example, the document indicator 608 is shown as a document category 622 indicating 12 documents associated with a candidate available for viewing. The notes indicator 610 is illustrated as a notes category 624 indicating two notes available for viewing. An activity log and ratings category 626 provides a log of all activities that have occurred during the application process for the candidate and also provides ratings received from any one or more users that have reviewed the candidate information. The communication data category 628 provides contact information for the candidate.

When the user selects a category of the candidate detailed screen 620 for further information, the category expands to provide its corresponding information. Each of the categories will be discussed in further detail below. While FIG. 6b illustrates certain categories, alternative embodiments may comprise more, less, or alternative categories.

Referring now to FIG. 6c, the candidate detailed screen 620 is shown with the document category 622 expanded. Within the document category 622, each of the documents is shown as a thumbnail. Due to the size of the display, only five document thumbnails are shown in the example of FIG. 6c. However, it is noted that in alternative embodiments, any number of documents may be displayed depending on, for example, the size of the thumbnails, orientation of the mobile device 106 (e.g., landscape or portrait mode), size of the display. If not all documents are displayed, the user may scroll to the left or right on a row to access the rest of the document thumbnails that are available for viewing. A marker 635 provides an indication that more documents are viewable if the user scrolls to the right. The user may select one of the thumbnails in the document category 622 in order to access a full-sized version of the document.

A resume thumbnail 630 is shown having a bookmark indicator 632 and a note indicator 634. The bookmark indicator 632 provides a visual tag for a document that the user will likely want to access during an interview. In some embodiments, bookmarked document thumbnails will be shown first in the row. In other embodiments, the user may position the documents in the order that they prefer or the HR system 202 may have a predetermined order.

A note indicator 634 indicates that the user has inserted a note in the document represented by the thumbnail. If the user selects the resume thumbnail 630, the full resume document will be shown to the user including the note indicator 634. The user may then select the note indicator 634 and view the note.

Referring now to FIG. 6d, the candidate detailed screen 620 is shown with the notes category 624 expanded. As shown, there are two notes in the notes category 624. Each note may be dated and timestamped. A first note 636 is a general note related to the candidate (e.g., not associated with a document) provided by one of the users (e.g., reviewers of the candidate information). A second note 638 is a note related to a document. As such, the second note 638 provides a link to the document that contains the note. In this case, the note is contained in the resume document. When the user selects the link (e.g., Resume.pdf), the resume document will be displayed. In example embodiments, the two types of notes may be distinguished from each other use visual means such as a different color. For example, notes related to the candidate may have a white background, while notes related to a document may have a blue background.

FIG. 6e illustrates the activity log and ratings category 626 expanded on the candidate detailed screen 620. In the example of FIG. 6e, a list or log of all activities that have occurred during the application process for the candidate is shown on one side of the activity log and ratings category 626. The log may be sorted by date and report an activity and a user that conducted the activity. For example, a telephone interview was conducted by Peter Shaw on May 1, 2011.

On the other side of the activity log and ratings category 626, ratings from users that have reviewed the candidate information or conducted an activity with the candidate is shown. A rating 639 located at the top of the screen 620 may be an individual rating provided by the user for the candidate.

Referring now to FIG. 6f, the communication data category 628 is expanded on the candidate detailed screen 620. The expansion of the communication data category 628 provides the contact information for the candidate. In the present example, the candidate's e-mail address, telephone number, mobile phone number, and mailing address are displayed. Additionally, links to various networking sites including social networking sites are provided. For example, links are provided to the candidate's Xing profile and LinkedIn profile. A further link is provided to the candidate's website. While certain examples of contact information are provided in FIG. 6f, any form of contact information may be used.

FIG. 6g illustrates an example evaluation screen 640. The user may provide feedback on the evaluation screen 640 during the review of the candidate information or upon completion of the interview. The evaluation screen 640 may allow the user to provide feedback in various ways such as, for example, filling in text boxes, selecting entries, using drop down menus, or any other form of feedback input. For example, the user may select one entry in a “decision of line manager after interview” section 642. The user may also provide remarks for their selection in a remarks field 644. When the user has completed entries on the evaluation screen 640, the user may select a complete and submit button 646.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner, or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

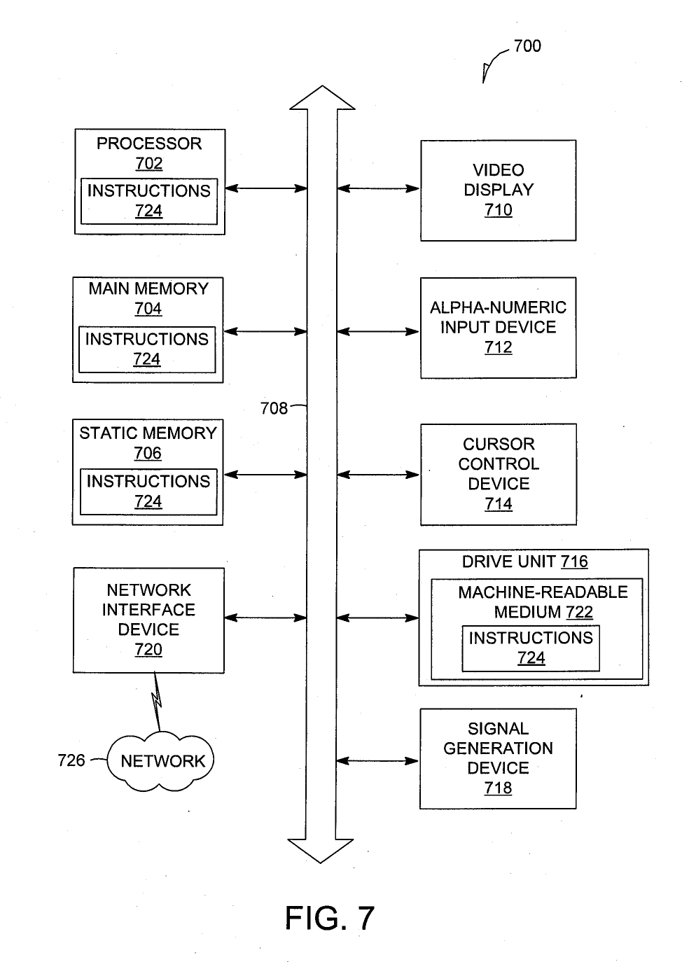

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In example embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

The disk drive unit 716 includes a machine-readable storage medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable storage medium 722 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A non-transitory machine-readable storage medium in communication with at least one processor, the non-transitory machine-readable storage medium storing instructions, which when executed by the at least one processor of a machine, cause the machine to perform operations comprising:
receiving, at a user device, a request to access candidate information for at least one candidate from a backend system;
providing the request including an identifier of a user of the user device to the backend system via a communication network; and
receiving, from the backend system, candidate information for the at least one candidate designated for the user based on the identifier.

2. The non-transitory machine-readable storage medium of claim 1, wherein the operations further comprise:
receiving assessment information for the at least one candidate; and
providing the assessment information to the backend system for storage.

3. The non-transitory machine-readable storage medium of claim 2, wherein the assessment information comprises a selection of at least one of a rating, indication of acceptance, indication of rejection, recommendation, or feedback.

4. The non-transitory machine-readable storage medium of claim 1, wherein the operations further comprise:
receiving a bookmark indication for at least one document of the candidate information; and
providing the bookmark indication for the at least one document to the backend system for storage.

5. The non-transitory machine-readable storage medium of claim 1, wherein the operations further comprise:
receiving a remark that is viewable by others viewing the candidate information; and
providing the remark to the backend system for storage.

6. The non-transitory machine-readable storage medium of claim 1, wherein operations further comprise receiving a sort command that filters a worklist containing at least one candidate assessment from the backend system.

7. The non-transitory machine-readable storage medium of claim 1, wherein the operations further comprise receiving a selection of a document, the operations further comprising providing a full screen of the selected document.

8. The non-transitory machine-readable storage medium of claim 1, wherein the operations further comprise receiving a selection of a note icon, the operation further comprising providing a full text of the selected note.

9. The non-transitory machine-readable storage medium of claim 1, wherein the operations further comprise receiving an indication of a completed activity, the operations further comprising causing an update to an activity log with the completed activity.

10. The non-transitory machine-readable storage medium of claim 1, wherein the operations further comprise receiving a note from the user, the note being viewable by the user; and
locally storing the note at the user device.

11. The non-transitory machine-readable storage medium of claim 1, wherein the operations further comprise receiving a selection of a category of a detailed candidate screen, the operations further comprising expanding the category for display of more detailed candidate information.

12. The non-transitory machine-readable storage medium of claim 11, wherein the category is a document category, the expanding of the category comprising displaying thumbnails of documents of the candidate information for the at least one candidate.

13. The non-transitory machine-readable storage medium of claim 11, wherein the category is a notes category, the expanding of the notes category comprising displaying notes inputted for the at least one candidate.

14. The non-transitory machine-readable storage medium of claim 11, wherein the category is an activity log category, the expanding of the activity log category comprising displaying a log of activities performed with the at least one candidate.

15. A method comprising:
receiving, at a backend system, a request for access to candidate information from a user device via a communication network, the request including an identifier;
determining an identity of a user of the user device based on the identifier; and
providing, using at least one processor, access to the candidate information designated for the user of the user device based on the identifier.

16. The method of claim 15, further comprising:
receiving assessment information for a candidate corresponding to the requested candidate information from the user device; and
storing the assessment information to the candidate information for the candidate at the backend system.

17. The method of claim 16, further comprising:
providing a success message to the user device indicating successful submission of the assessment information; and
removing the candidate from a worklist of the user based on the successful submission of the assessment information.

18. The method of claim 15, further comprising:
receiving a remark from the user device; and
storing the remark to the candidate information for a candidate at the backend system.

19. The method of claim 15, further comprising:
receiving a bookmark indication for a document of a candidate from the user device; and
storing the bookmark indication for the document to the candidate information for the candidate at the backend system.

20. The method of claim 15, further comprising providing an interview assistant application for download to the user device.
